(19) United States
(12) Patent Application Publication
(10) Pub. No.: US 2008/0093781 A1
(43) Pub. Date: Apr. 24, 2008

(54) HIGH PRESSURE, TWIN CYLINDER EXOTHERMIC BACKPACK CUTTING SYSTEM

(76) Inventors: Jim Stanton, Chula Vista, CA (US); Don Le Fevre, Chula Vista, CA (US)

Correspondence Address: STEVEN W. WEBB, 655 2ND STREET, ENCINITAS, CA, 92024, US

(21) Appl. No.: 11/739,440

(22) Filed: Apr. 24, 2007

Related U.S. Application Data
(60) Provisional application No. 60/853,188, filed on Oct. 21, 2006.

(51) Int. Cl. B23K 7/08; B21D 53/00

(52) U.S. Cl. 266/75; 29/890.02

(57) ABSTRACT

An improved exothermic cutting system is presented mounted upon a standard Alice pack frame reduced by three inches for additional comfort and safety to the wearer. A lightweight aluminum plate is welded to the Alice pack for stability while serving as a rigid platform upon which the cylinders, manifold, battery ignition and rod compartment is secured. The backpack design provides oxygen via an oxygen hose to the cutting torch. The design also provides a dual extruded electrical cable connected to a 12 volt battery at one end, and an igniter head at the other end, necessary to initiate the exothermic reaction.

Overall, the improved backpack system allows for greater comfort and convenience. The improves system also protects the components from damage during deployment. In numerous trials, military breaching personnel, police officers and emergency response personnel have found the new backpack cutting system an indispensable tool for gaining rapid entry or rapid egress in diverse military and commercial settings.

The dual, high pressure, Kevlar-wrapped cylinders, with high pressure manifold, provides greater cutting pressure to melt through thick materials in less time than existing exothermic cutting systems. The additional pressure reserve in the cylinders allows for longer cutting duration, indispensable for military and commercial cutting assignments. The modified high pressure manifold provides for augmented capacity in addition to the ability to fill the tanks in situ.

### RELATED APPLICATIONS

This application claims the benefit of Provisional Application 60/853,188, dated Oct. 21, 2006.

### FIELD OF THE INVENTION

This invention relates to exothermic cutting apparatuses, specifically man-portable exothermic cutting.

### BACKGROUND OF THE INVENTION

Exothermic cutting has been described in numerous patents, including U.S. Pat. Nos. 4,114,863, 4,416,444, and 5,000,426. Exothermic cutting operates on a traditional combustion triangle. One part of the combustion triangle encompasses an oxidizing gas satisfied by commercially available bottled oxygen. The second part of the combustion triangle encompasses a combustible fuel; customarily satisfied by a metal tube filled with oxidizing metal so the tube serves as a cutting consumable in addition to directing the oxygen stream for efficient removal of molten metal. The third part of the combustion triangle involves a heat source; generally a spark from a 12 volt battery. The combined result of the combustion triangle is classified by the American Welding Society as an exothermic reaction capable of melting both ferrous, nonferrous, and refractory material due to its high operating temperature.

Like prior art, this patent also utilizes an oxidizing gas, consumable cutting tube, and a catalytic spark to manifest an exothermic flame used for cutting, gouging and piercing materials. The differences in this patent versus prior use involves twin, high pressure cylinders plumbed together with a high pressure manifold firmly attached to a backpack frame. The high pressure manifold not only allows for shared oxygen capacity; the manifold allows both cylinders to be hot filled via a convenient CGA fitting without removing the cylinders from the backpack. This feature is indispensable for rapidly changing contingencies confronted in both military and commercial settings.

Where other exothermic systems utilize cylinders limited to 2000 psi, this system differs in its use of twin, lightweight, composite oxygen cylinders, subsequently wrapped in kevlar to withstand 3000 psi fill pressures. The elevated fill pressures provide significantly greater cutting pressure over existing 2000 psi cylinders in addition to elevated cutting capacity and cutting duration. The customary 12 volt ignition is secured to the backpack enabling the system to be fully functional without external support. Overall, the small size and lightweight design of the cylinders allow for greater portability and access through small openings over existing systems, making such a system highly applicable to ship deployment and related breaching assignments.

In numerous trials, military breaching personnel, police officers and emergency response personnel have found the new backpack cutting system invaluable for gaining rapid entry or rapid egress in challenging tactical and rescue situations.

### SUMMARY OF THE INVENTION

The rapidly changing needs of commercial and government agencies demands man-portable exothermic cutting systems. Current portable exothermic cutting systems utilize dual cylinder oxygen tanks housed in a freestanding fixture with the tanks connected by means of the interlocking gas manifold. As an alternative, dual cylinder oxygen tanks have also been loosely mounted on Alice Pack backpacks. Ad hoc versions have been developed for special warfare personnel directed to gain immediate access to otherwise impenetrable structures.

Loose oxygen cylinders on existing systems are prone to slippage and are frequently dropped in haste on hard substrates resulting in damage. During such circumstances, the absence of an adequate restraint fails to adequately protect the user from life threatening hazards associated with cylinder damage. This invention secures the cylinders to the pack so that they cannot slip. Moreover, the cylinders are secured so if the pack is dropped, the lower portion of the pack comes into contact with the substrate, thus protecting the bottom of the cylinders from damage. For additional safety, the battery pack is affixed to the backpack, making it impervious to snagging. In tight quarters, the integrated, small footprint design allows for rapid, safe egress in contrast to larger units currently available.

### BRIEF DESCRIPTION OF THE DRAWINGS

FIG. 1 Exploded view of the invention

FIG. 2 Cutaway view of the invention

FIG. 3 Side view of the invention

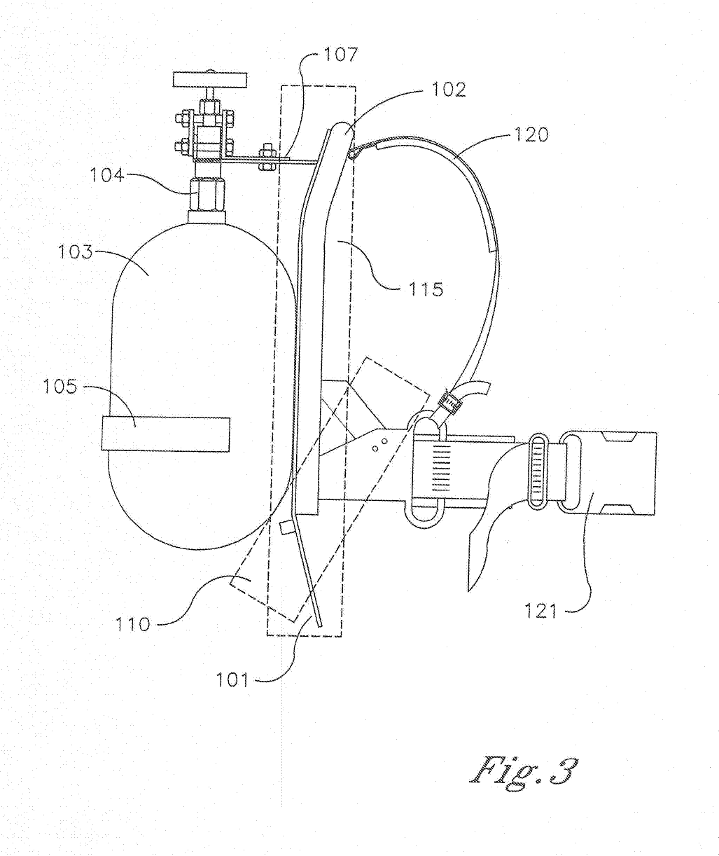

FIG. 4 Opposite side view of the invention

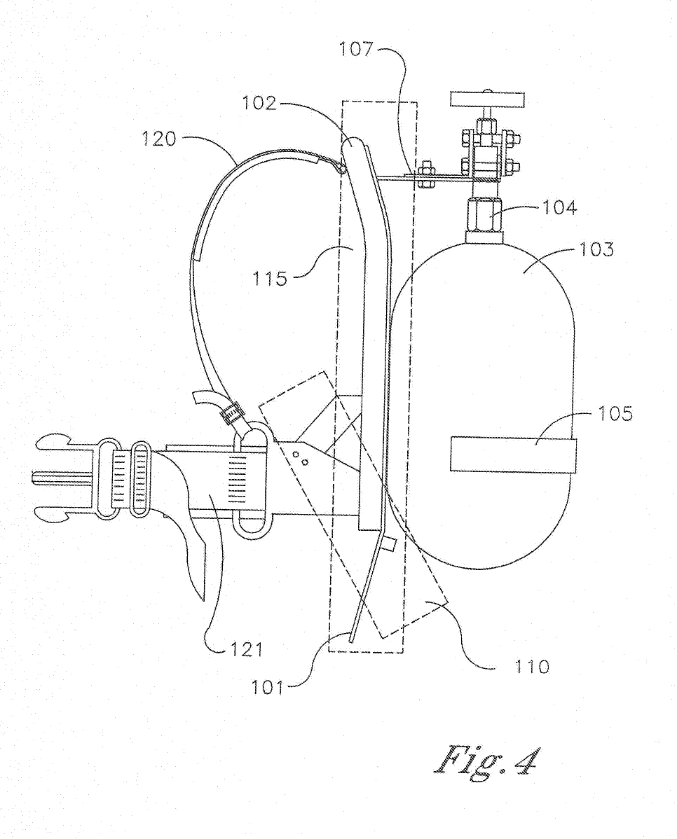

FIG. 5 Backpack and plate

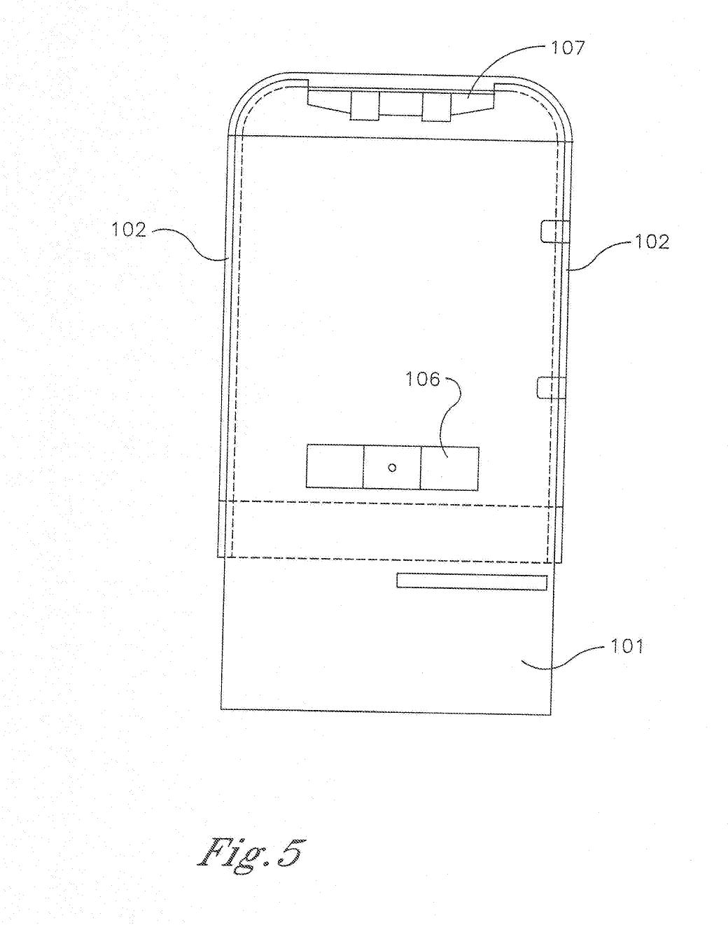

FIG. 6 Side view of backpack and plate

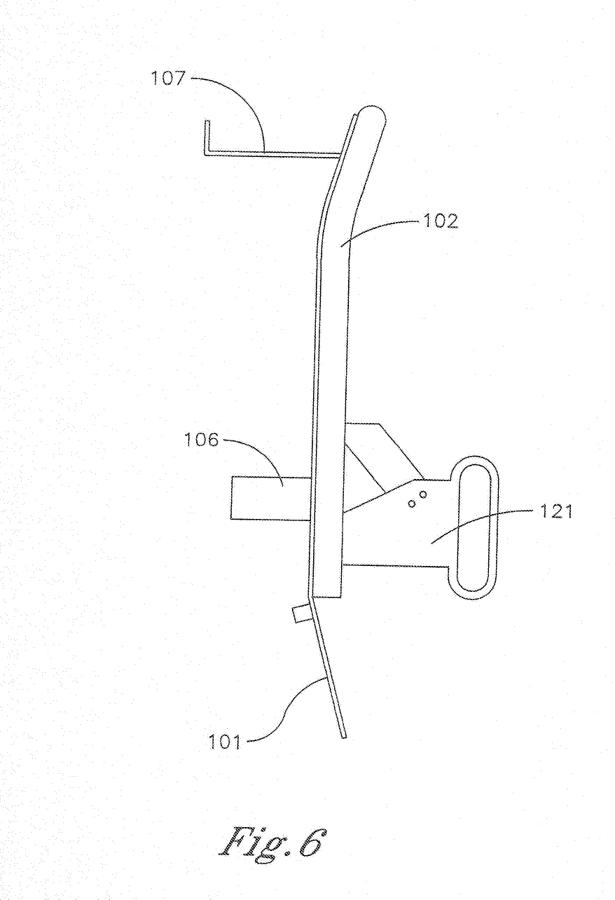

### DETAILED DESCRIPTION OF THE INVENTION

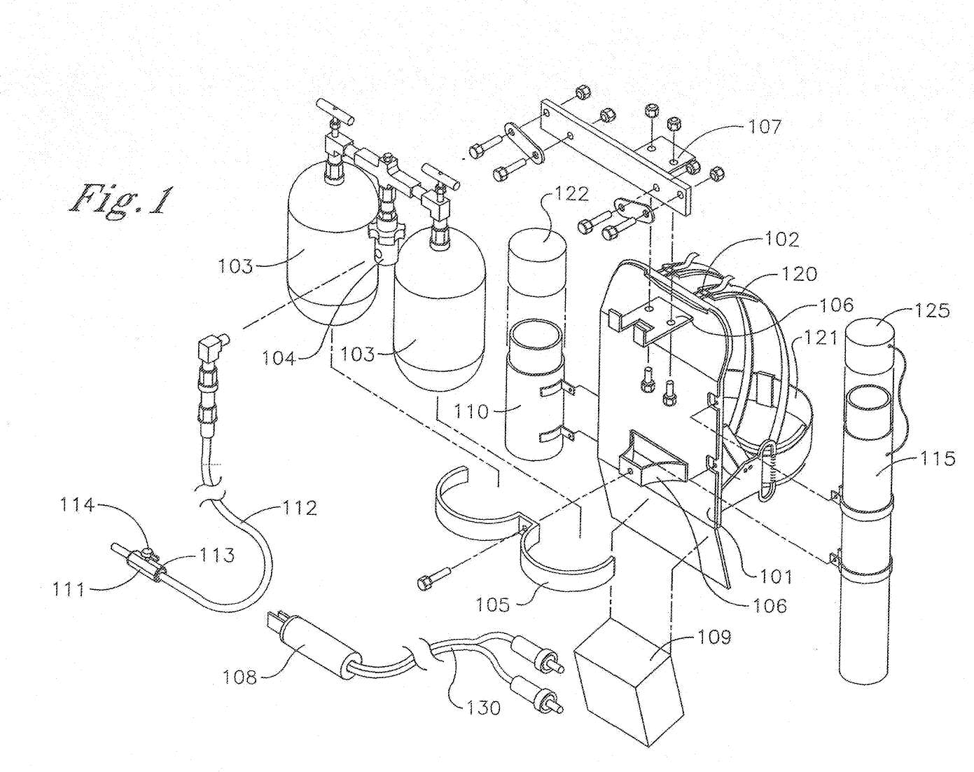

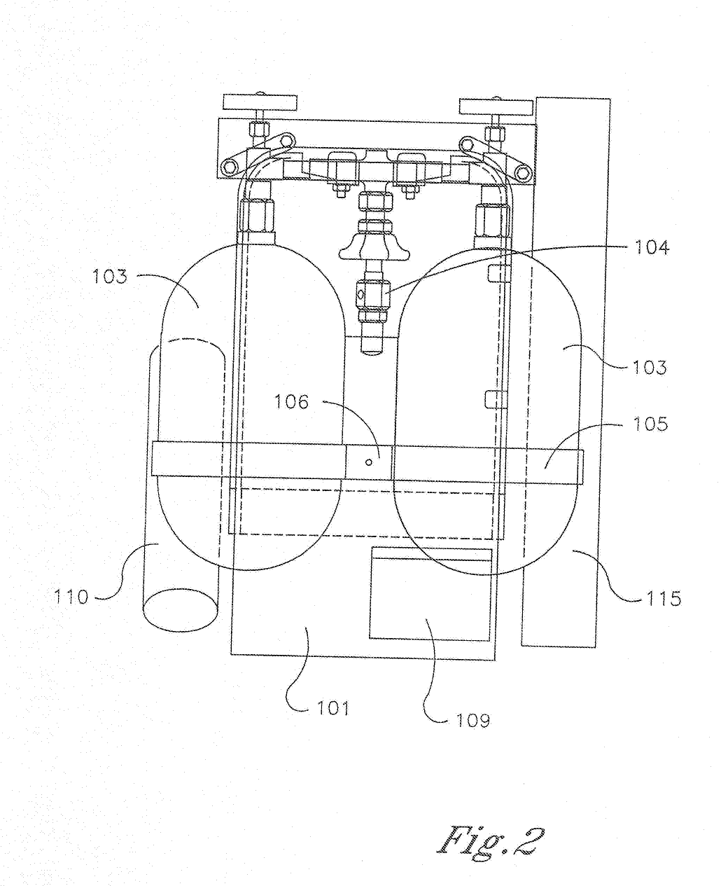

The invention 100, as shown in FIG. 1 and FIG. 2, is a lightweight aluminum plate assembly 101 which is welded to a standard Alice Pack frame 102. The Alice Pack frame 102 has been cut down by three inches to fit the plate 101 and maximize portability and comfort. The plate 101 possesses a plurality of mounting brackets 106 and fittings 107 to which the two Kevlar-wrapped oxygen tanks 103 with their high-pressure gas manifold 104 are attached. The Kevlar-wrapped tanks 103, with high pressure gas manifold 104, provides greater cutting pressure to melt through thick materials in less time than prior art exothermic cutting systems. There are two restraining loops 105 that rigidly hold the oxygen tanks 103 to each other and to the aluminum plate 101. The high pressure gas manifold 104 provides increased gas capacity in addition to the ability to fill the tanks 103 in the field.

Mounted on the bottom of the plate 101 is a battery pack 109 and an electric arc lighter 108. The present invention also provides a dual extruded electrical cable 130 connected to the battery pack 109.

The cutting torch 111 is attached to the manifold 104 via an oxygen line 112. The torch is comprised of a collect chuck 113 and a valve 114. The cutting rod containers 115 and fire suppression system 110 are mounted rigidly to the frame 102. The cutting rod containers possess a restraining cap 125 to close the open end of the container 115 to prevent cutting rods from falling out during transportation. The fire suppression system possesses a similar restraining cap 122 to retain the fire suppressor (not shown) within it. The surface of the metal components are powder coated in powder black to minimize weathering.

The invention is secured to the user by means of the straps 120 and buckles 121 of the modified Alice pack frame 102. When properly strapped to the user, the system components are tightly and removably secured to the plate 101 which is fixedly attached to the Alice pack, eliminating the problem of cutting torch gas manifold twisting, loss of cutting rods, or damage to or loss of the battery pack. Because of the tight fit of the invention 100 to the user, it is comfortable and easier to carry during violent physical evolutions, such as diving or parachuting.

While the foregoing describes a preferred embodiment of the invention, variation on this design and equivalent designs may be resorted to in the scope and spirit of the claimed invention.

What is claimed is:

1. a cutting torch pack assembly, the pack assembly comprised of a modified Alice pack, a base plate, a plurality of mounting brackets, a plurality of fittings, two oxygen tanks, a gas manifold connecting the two oxygen tanks, a cutting torch, an electric arc lighter system, a cutting rod container, a fire suppression container, and a restraining loop,
the modified Alice pack an industry-standard Alice pack that is reduced in length by three (3) inches, the modified Alice pack possessing straps and buckles to be used to secure the cutting torch pack assembly to a human torso,
the base plate a curved plate comprised of a rigid material,
the cutting torch comprised of an oxygen line, a collect chuck, and a gas valve,
the electric arc lighter system comprised of a battery pack that is removably connected to the base plate with brackets, a lighter cable, and an arc lighter,
the restraining loop a double arc of rigid material that holds the oxygen tanks to the base plate by means of mounting brackets and fittings that are removably attached to it and the base plate,
the cutting rod container a hollow cylinder with an open end possessing a restraining cap which is removably fitted over the open end of the cutting rod container,
the cutting torch connected to the gas manifold by means of the oxygen line.

2. A method of assembling a cutting torch pack assembly which is comprised of the steps of
welding the base plate to the modified Alice pack,
removably attaching the battery pack to the base plate,
attaching the oxygen tanks connected to each other by the gas manifold to the base plate by means of securing the restraining loop around the oxygen tanks, attaching the restraining loops to the base plate by means of mounting brackets and fittings,
removably attaching the cutting rod container to the modified Alice pack by means of mounting brackets,
placing a restraining cap over the open end of the cutting rod container,
connecting the cutting torch to the gas manifold by removably connecting the oxygen line to the gas manifold.
